(19) United States
(12) Patent Application Publication
(10) Pub. No.: US 2012/0200951 A1
(43) Pub. Date: Aug. 9, 2012

(54) CONTENT DUPLICATION DEVICE AND CONTENT DUPLICATION SYSTEM

(75) Inventors: Takeshi Koda, Tokyo (JP); Katsutoshi Inagaki, Saitama (JP); Akira Shimizu, Tokyo (JP); Hirokazu Oishi, Tokyo (JP); Masayoshi Yoshida, Saitama (JP); Tsuyoshi Hasebe, Saitama (JP); Tsuyoshi Namiki, Saitama (JP)

(73) Assignee: PIONEER CORPORATION, Kanagawa (JP)

(21) Appl. No.: 13/502,019

(22) PCT Filed: Oct. 21, 2009
(86) PCT No.: PCT/JP2009/068138

§ 371 Date: Apr. 13, 2012

(51) Int. Cl. G11B 5/86

(52) U.S. Cl. 360/15; G9B/5.308

(57) ABSTRACT

A duplication device is provided. When content is duplicated by recording, in a recording medium of a recording destination, the same content as content recorded in a recording medium of a duplication source, even if a reading speed is slower than a writing speed, the duplication device can reduce a duplication time as much as possible. The duplication device 100 reads a reading portion of content from an optical disc D in which content is recorded, and in parallel to this reading, downloads a transmission portion which includes a portion of content other than the reading portion, from a distribution server 200, and records the read reading portion and the downloaded transmission portion in the hard disc 106 at a speed faster than a speed of reading the reading portion.

### TECHNICAL FIELD

The present invention relates to a content duplication device.

### BACKGROUND ART

Conventionally, content is frequently duplicated from recording media to recording media. For users who duplicate content in this way, the shorter duplication time, the better.

Further, duplication is performed by writing (also referred to “recording”) content read from a recording medium of a duplication source into a recording medium of a duplication destination. In this case, if the speed of reading content from a recording medium of a duplication source is faster than the speed of writing content in a recording medium of a duplication destination, this slow reading speed blocks reduction of the duplication time.

Meanwhile, multiple techniques of reducing the time required for duplication are published. For example, following Patent Literature 1 discloses a technique of partitioning a recording medium into a plurality of memory regions and providing a reading/writing device which supports each memory region. This technique can improve both of the reading speed and the writing speed, and reduce the duplication time.

### CITATION LIST

### Patent Literature

Patent Literature 1: Japanese Patent Application

Laid-Open No. 8-161752

### SUMMARY OF INVENTION

### Technical Problem

However, when, for example, content read by a reading device different from a device according to the invention of Patent Literature 1 is written by the device according to the invention of Patent Literature 1, if the writing speed is slower than the reading speed, this slow reading speed ends up in blocking reduction of the duplication time.

The present invention has been made in view of the above problem, and an example of an object of the present invention is to provide a content duplication device and a content duplication system which, when the same content as content recorded in a recording medium of a duplication source is duplicated by recording the content in a recording medium of a duplication destination, even if a speed of reading the content from the recording medium of the duplication source is slower than a speed of writing the content in the duplication destination, can reduce the likelihood that the slow reading speed blocks reduction of the duplication time and eventually reduce the duplication time.

### Solution to Problem

The invention according to claim 1 is a content duplication device comprising:

reading means for reading a first portion configuring content from a first recording medium in which the content is recorded;

acquiring means for, in parallel to the reading of the first portion by the reading means, acquiring a second portion which is different from the first portion and which configures the content, from a second recording medium which is different from the first recording medium and in which at least a portion of a same content as the content is recorded; and

recording means for recording the first portion read by the reading means and the second portion acquired by the acquiring means in a third recording medium at a speed faster than a speed at which the reading means reads the first portion.

The invention according to claim 10 is a content duplication system comprising:

a content duplication device which duplicates content recorded in a first recording medium; and

a content distribution device which distributes at least a portion of content,

wherein the content duplication device comprises:

reading means for reading a first portion configuring the content from the first recording medium;

acquiring means for, in parallel to the reading of the first portion by the reading means, acquiring a second portion which is different from the first portion and which configures the content, from the content distribution device which is a medium different form the first recording medium; and

recording means for recording the first portion of the content read by the reading means and the second portion of the content acquired by the acquiring means in a third recording medium at a speed faster than a speed at which the reading means reads the first portion, and

the content distribution device comprises:

distribution content memory means for storing a plurality types of distribution content; and

transmitting means for transmitting the second portion to the content duplication device.

The invention according to claim 11 is a content duplication system comprising:

a content duplication device which duplicates content recorded in a first recording medium;

a content distribution device which distributes content; and

a content memory device which stores the content distributed from the content distribution device,

wherein the content duplication device comprises:

reading means for reading a first portion of the content from the first recording medium;

list receiving means for receiving, from the content distribution device, a list of distribution destinations to which the content distribution device has previously distributed a same content as the content recorded in the first recording medium;

acquiring means for, in parallel to the reading of the first portion by the reading means, acquiring a second portion which is different from the first portion and which configures the content, from the content memory device which is a medium different form the first recording medium and which is included in the received list; and

recording means for recording the first portion of the content read by the reading means and the second portion of the content acquired by the acquiring means in a third recording medium at a speed faster than a speed at which the reading means reads the first portion,

the content distribution device comprises:

distribution content memory means for storing a plurality types of distribution content; and

distribution history management means for managing distribution history information showing that content is distributed to which one of the content memory devices, per content stored in the distribution content memory means; and

list transmitting means for transmitting, to the content duplication device, a list which is based on the distribution history information and which includes the content memory devices to which same content as the content recorded in the first recording medium has been distributed, and

the content memory device comprises transmitting means for transmitting the second portion to the content duplication device.

### BRIEF DESCRIPTION OF DRAWINGS

FIG. 1 is a block diagram of a duplication system 1 according to a first embodiment.

FIG. 2A to FIG. 2D are conceptual diagrams for describing a flow of duplication processing according to the first embodiment.

FIG. 3 is a flowchart illustrating an example of duplication processing executed by a control unit 101 of the duplication device 100 and a control unit 201 of a distribution server 200 according to the first embodiment.

FIG. 4 is a flowchart illustrating an example of duplication processing executed by the control unit 101 of the duplication device 100 and the control unit 201 of the distribution server 200 according to the first embodiment.

FIG. 5A, and FIG. 5B are conceptual diagrams for describing a flow of duplication processing.

FIG. 6 is a block diagram of a duplication system 2 according to a second embodiment.

FIG. 7 is a flowchart illustrating an example of duplication processing executed by the control unit 101 of the duplication device 100, the control unit 201 of the distribution server 200 and a control unit of an available duplication device 300 according to the second embodiment.

FIG. 8 is a flowchart illustrating an example of available duplication device list creating processing executed by the control unit 201 of the distribution server 200 according to the second embodiment.

### REFERENCE SIGNS LIST

100 DUPLICATION DEVICE
101 DUPLICATION DEVICE/CONTROL UNIT
102 DUPLICATION DEVICE/OPTICAL DISC READING UNIT
103 DUPLICATION DEVICE/READING BUFFER
104 DUPLICATION DEVICE/COMMUNICATION UNIT
105 DUPLICATION DEVICE/COMMUNICATION BUFFER
106 DUPLICATION DEVICE/HARD DISC
107 DUPLICATION DEVICE/OPERATION UNIT
200 DISTRIBUTION SERVER
201 DISTRIBUTION SERVER/CONTROL UNIT
202 DISTRIBUTION SERVER/COMMUNICATION UNIT
203 DISTRIBUTION SERVER/COMMUNICATION BUFFER
210 DISTRIBUTION SERVER/AUTHENTICATION DB
220 DISTRIBUTION SERVER/CONTENT DB
230 DISTRIBUTION SERVER/DISTRIBUTION MANAGEMENT DB
300 AVAILABLE DUPLICATION DEVICE
D OPTICAL DISC

### DESCRIPTION OF EMBODIMENTS

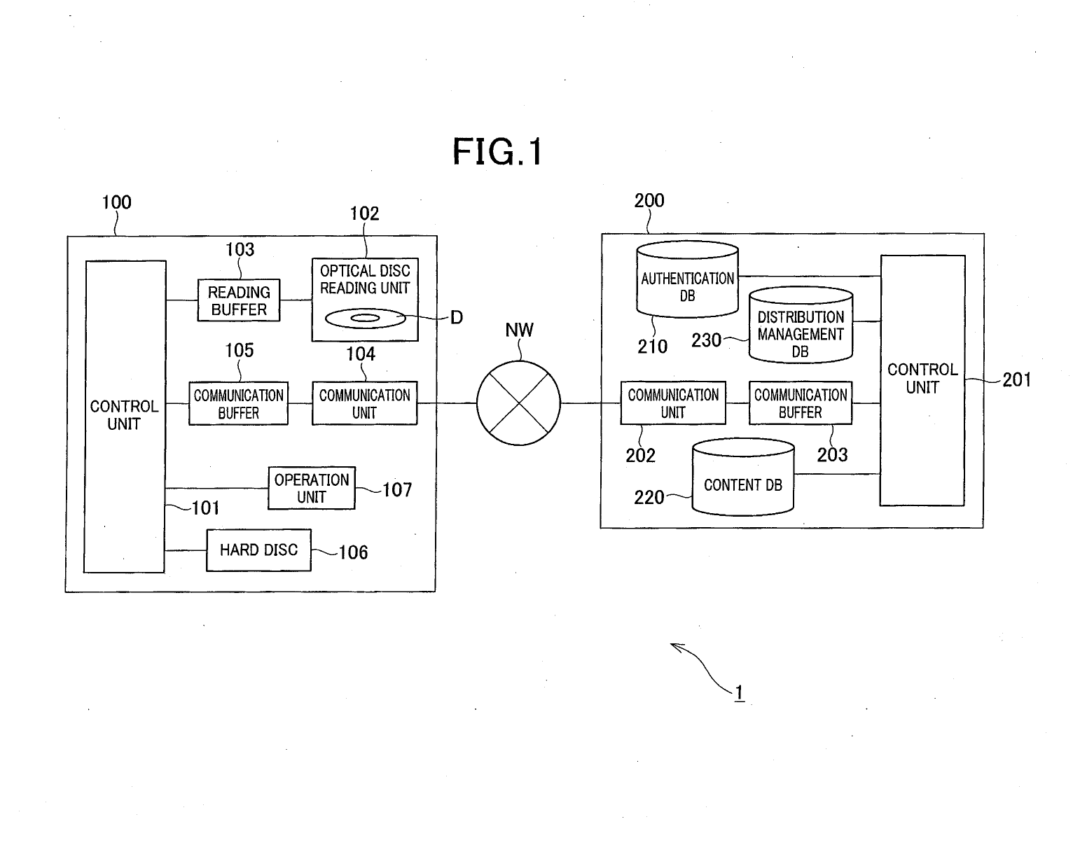

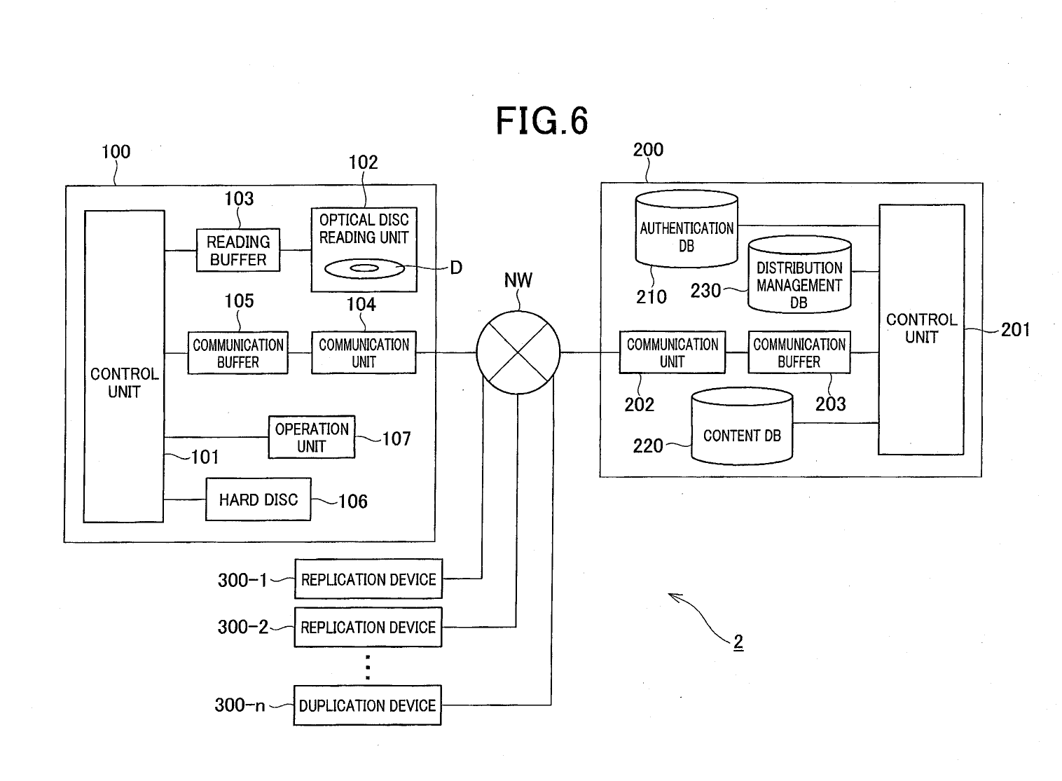

Embodiments of the present invention will be described using FIGS. 1 to 8. With the following embodiments, as illustrated in FIGS. 1 and 6, a duplication device 100 duplicates content by recording in a hard disc 106 the same content as content recorded in an optical disc D.

### First Embodiment

First, the first embodiment will be described using FIGS. 1 to 4. With the first embodiment, as illustrated in FIG. 1, a duplication system 1 has a duplication device 100 and a distribution server 200, and the duplication device 100 duplicates content by reading a portion of content from an optical disc D, and, in parallel, downloading the other portion from the distribution server 200 and recording the portion and the other portion in a hard disc 106. In addition, with the first embodiment, a duplication aid refers to, when the duplication device 100 duplicates content, aiding this duplication by uploading a portion of content from the distribution server 200 to the duplication device 100.

The duplication device 100 has a control unit 101, an optical disc reading unit 102, a reading buffer 103, a communication unit 104, a communication buffer 105, a hard disc 106 and an operation unit 107.

A control unit 101 employs a configuration mainly including a CPU and has memories such as a ROM and a RAM, and the CPU reads various control programs stored in the ROM and executes a program using the RAM where necessary to perform various control of the duplication device 100. Particularly, when detecting a user's operation for starting processing (referred to as “duplication processing”) of recording in the hard disc 106 the same content as content recorded in the optical disc D, the control unit 101 executes a duplication program for performing duplication processing.

When executing duplication processing, the control unit 101 transmits and receives data to and from the distribution server 200 to perform various preprocessings described below before downloading data from the distribution server 200. In this case, the control unit 101 uses the communication buffer 105 where necessary when, for example, a downloading speed S_{S} from the distribution server 200 or an uploading speed to the distribution server 200 is slow. Further, the control unit 101 adequately measures the downloading speed S_{S} which changes from time to time depending a use situation of a network NW line, and which is used to download data from the distribution server 200.

The control unit 101 performs allocation determining processing of determining a data size of a portion of content (“reading portion”) of a duplication target read from the optical disc D and a data size of a portion (“transmission portion”) downloaded from the distribution server 200 before starting reading data from the optical disc D and downloading data from the distribution server 200, and allocates the reading portion and the transmission portion of the duplication target content.

In allocation determining processing, the control unit 101 determines the data size of the reading portion and the data size of the transmission portion to simultaneously complete reading the reading portion and downloading the transmission portion, and allocates the reading portion and the transmission portion. When finishing allocating the reading portion and the transmission portion, the control unit 101 starts reading the reading portion and writing the reading portion in the hard disc 106 (that is, duplicating the reading portion), downloading the transmission portion and writing the transmission portion in the hard disc 106 (that is, duplicating the transmission portion).

Meanwhile, the downloading speed S_{S} is not constant at all times, and, in some cases, duplication of the reading portion or duplication of the transmission portion is completed earlier. Hence, until duplication of all portions of content is completed, the control unit 101 repeats duplication of the reading portion or duplication of the transmission portion accompanying allocation determining processing for the portion which is not yet duplicated (“duplication uncompleted portion”) every time duplication of the reading portion or duplication of the transmission portion is completed.

The control unit 101 records the data downloaded from the distribution server 200, in the hard disc 106 when duplication is aided by the distribution server 200. In this case, when the writing speed with respect to the hard disc 106 is slower than the downloading speed S_{S}, the control unit 101 controls the communication buffer 105 to temporarily hold data which is not yet written.

The optical disc reading unit 102 is locally connected to the control unit 101 (for example, through a bus circuit or SAN (Storage Area Network) connection). Under control of the control unit 101, the optical disc reading unit 102 records in the reading buffer 103 the reading portion of content stored in the duplication device 100 by the user while reading the content from the optical disc D at a predetermined reading speed S_{D}. When the optical disc reading unit 102 is reading the reading portion, the control unit 101 sequentially reads data recorded in the reading buffer 103 one after another, and records the data in the hard disc 106.

When reading the reading portion from the optical disc D in duplication processing, if a reading error of irrecoverable data occurs, the optical disc reading unit 102 transmits to the control unit 101 error information showing that the reading error occurs and showing a portion (“error portion”) at which the reading error occurred. By contrast with this, when receiving error information, the control unit 101 sends to the distribution server 200 an error portion transmission request for requesting transmission of data corresponding to the error portion. Further, the control unit 101 receives data corresponding to the error portion transmitted from the distribution server 200 in response to the error portion transmission request, replaces the reading portion which cannot be read by the optical disc reading unit 102 with the received data, and records the data in the hard disc 106.

The communication unit 104 functions as an interface when the control unit 101 transmits and receives various items of data to and from the distribution server 200 connected through the network NW such as Internet. When, for example, transmitting and receiving data to and from, for example, another device such as the distribution server 200, the communication unit 104 converts the data according to, for example, a protocol.

The hard disc 106 has a system data memory region and a content memory region. The system data memory region stores, for example, various control programs, and the content memory region stores content. Content stored in the content memory region includes, for example, whole content downloaded from the distribution server 200 by way of, for example, a billing procedure, and content recorded by duplication processing. Further, although the control unit 101 writes data in the hard disc 106, the speed of writing data in the hard disc 106 is faster than the speed at which the optical disc reading unit 102 reads data from the optical disc D. In addition, apart from duplication processing, the control unit 101 performs processing of downloading whole content from the distribution server 200, and recording the content in the hard disc 106 in some cases.

The operation unit 107 employs a configuration including, for example, various buttons (not illustrated) which are operated when a user specifies processing content which the user makes the duplication device 100 execute, and transmits a processing content signal showing processing content to be executed, to the control unit 101 according to a type of a button operated by the user. When, for example, a duplication processing start button (not illustrated) is operated, a processing content signal showing that duplication must be started is transmitted to the control unit 101.

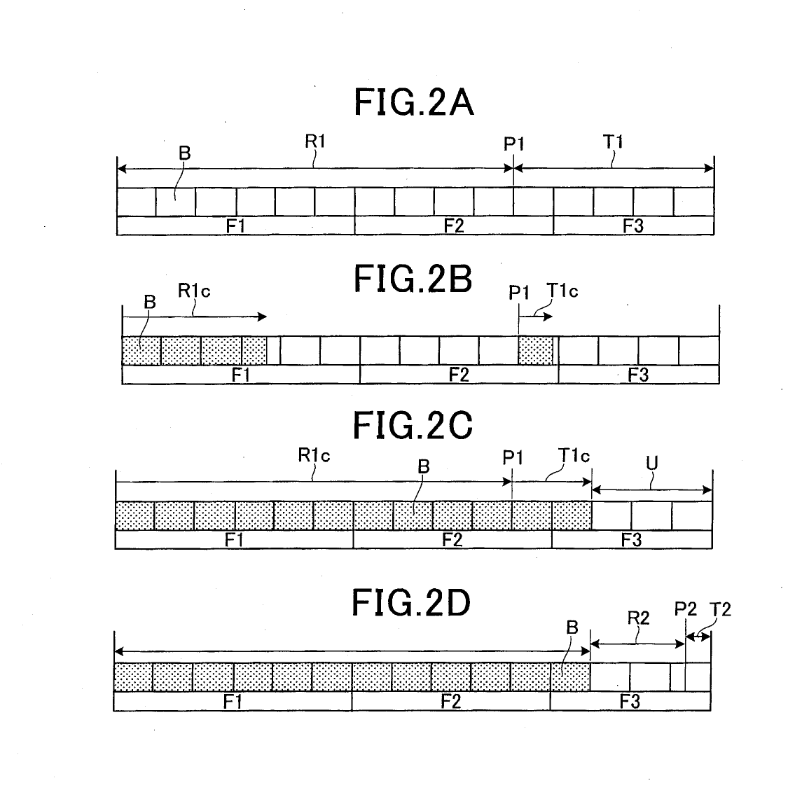

Next, the flow of recording content in the hard disc 106 upon duplication processing will be described with reference to FIGS. 2A to 2D. First, the control unit 101 determines a data size X of a reading portion R of data to be duplicated and a data size Y of a transmission portion T according to allocation determining processing. Parameters used for allocation determining processing includes a reading speed S_{D}, a downloading S_{S} and a data size Fi (i=1, 2, 3, . . . and n:n=total number of files) of each file configuring content. The control unit 101 determines the data size X of the reading portion R and the data size Y of the transmission portion T based on these parameters and, for example, the following simultaneous equations (Equation (1-1) and Equation (1-2)). Meanwhile, the reading speed S_{D} is assumed to be a predetermined value which is determined according to performance of the optical disc reading unit 102, and the downloading speed S_{S} is measured before allocation distributing processing. In addition, the following equation is an example, and an equation of the optimal data allocation method is adequately designed according to a reading scheme of a drive or a file data position.

$$\begin{matrix}[ Equation 1 ] & \\ X = {S}_{D} / {S}_{s} ) \times Y & ( 1 - 1 ) \\ X + Y = {\sum }_{i = 1}^{n} Fi & ( 1 - 2 )\end{matrix}$$

Next, this equation will be described using a specific example. Content of a duplication target is configured with a first file F1 (a file size is 18 GB (Giga Byte)), a second file F2 (a file size is 15 GB) and a third file F3 (a file size is 12 GB), the reading speed S_{D} is 100 Mbps and the downloading speed S_{S} (first time) is 50 Mbps.

In this case, according to above equation (1-1) and equation (1-2), the data size X of the reading portion R is 30 GB and the data size Y of the transmission portion T is 15 GB. As illustrated in FIG. 2A, when one file (content) is configured by arranging the first file F1, the second file F2 and the third file F3, the first reading portion R1 and transmission portion T1 are divided at a division point P1. In this case, the first file F1, the second file F2 and the third file F3 are arranged according to some rule such as an ascending order of file names. In addition, a division point (P1, P2, . . . and Pn) is a point for dividing the reading portion R (R1, R2, . . . and Rn) and the transmission portion T (T1, T2, . . . and Tn) for a duplication uncompleted portion. Further, a block B illustrated in FIG. 2 corresponds to 3 GB data itself.

When determining the reading portion R1 and the transmission portion T1, the control unit 101 starts duplicating a reading portion R1 and duplicating a transmission portion T1. Then, as the time passes, as illustrated in FIG. 2B, a duplication completed portion R1c of the reading portion R1 and a duplication completed portion T1c of the transmission portion T1 increase.

Further, when, for example, the downloading speed S_{S} decreases during execution of duplication processing, duplication of the reading portion R1 is completed as illustrated in FIG. 2C before duplication of the transmission portion T1 is completed. Thus, when duplication of the reading portion R1 or duplication of the transmission portion T1 is completed earlier due to the change of the downloading speed S_{S}, the control unit 101 performs allocation determining processing of the duplication uncompleted portion again. Meanwhile, the control unit 101 performs this allocation determining processing after measuring the downloading speed S_{S} again.

For example, a data size of a duplication uncompleted portion U illustrated in FIG. 2C is 9 GB, the reading speed S_{D} is 100 Mbps and the downloading speed S_{S} after re-measurement (second) is 25 Mbps. In this case, when the right side of above equation (1-2) is the data size (9 GB) of the duplication uncompleted portion U, X=7.2 GB and Y=1.8 GB hold, and a division point P2 is determined as illustrated in FIG. 2D. Further, the control unit 101 executes duplication of the re-determined reading portion R2 and duplication of the re-determined transmission portion T2 in parallel. Subsequently, the control unit 101 repeats the above processing until duplication of all portions of content is completed.

In addition, the control unit 101 manages a content recorded state by managing address information during execution of duplication processing. Address information is expressed by a file name and the number of bytes from the head of the file. Further, an address of the division point P and a copy completed address at a given point of time are managed using address information. For example, an address of the division point P1 illustrated in FIG. 2A is expressed as address information of “file name: second file F2” and “number of bytes from head of second file F2: 12 GB”. Thus, by managing and referring to address information for the reading portion R and the transmission portion T during execution of duplication processing, the control unit 101 learns a duplication completed portion and a duplication uncompleted portion of content which is being duplicated.

Next, the distribution server 200 will be described. As illustrated in FIG. 1, the distribution server 200 has a control unit 201, a communication unit 202, a communication buffer 203, an authentication DB 210, a content DB 220 and a distribution management DB 230.

The control unit 201 employs a configuration mainly including a CPU and has memories such as a ROM and a RAM, and the CPU reads various control programs stored in the ROM and executes a program using the RAM where necessary to perform various control of the distribution server 200.

When performing aid duplication, the control unit 201 transmits and receives data to and from the duplication device 100 to perform various preprocessings described below before uploading data to the duplication device 100. In this case, the control unit 201 uses the communication buffer 203 where necessary when, for example, a downloading speed or an uploading speed is slow.

The control unit 201 uploads the transmission portion T based on a duplication aid request and a downloading request of the transmission portion T of content from the duplication device 100. Further, when receiving the above error portion transmission request from the duplication device 100, the control unit 201 uploads data corresponding to the error portion to the duplication device 100.

The communication unit 202 functions as an interface when the control unit 201 transmits and receives various items of data to and from the duplication device 100 connected through the network NW such as Internet. When, for example, transmitting and receiving data to and from, for example, another device such as the duplication device 100, the communication unit 202 converts the data according to, for example, a protocol.

Under control of the control unit 201, the authentication DB 210 stores per user a user ID and a password which are referred to upon log-in processing of a user who utilizes the distribution server 200. The user's log-in processing is performed as one of preprocessings described below. Further, the authentication DB 210 stores billing information per user, and adds the amount of money matching duplication target content to user's billing information when billing processing is performed as one of the preprocessings described below.

The content DB 220 associates and stores a plurality of types of distribution content such as movies and animations with content unique IDs. When uploading the transmission portion T, the control unit 201 uploads a portion of distribution content which is associated with the content unique ID and is stored in the content DB 220. Meanwhile, although the content unique ID is information for uniquely identifying content, a content unique ID varying per optical disc D is allocated and recorded even in the optical disc D in which the same content is recorded. That is, a plurality of content unique IDs are associated with one content.

In addition, the content DB 220 may be configured to record the number of times of duplication aid requests per content unique ID, and the control unit 201 may be configured not to permit a duplication aid because of a concern of an illegitimate duplication aid request when duplication aid requests exceeding a predetermined number of times (the number of times which is sufficiently great as the number of times one user duplicates content), based on the same content unique ID.

Under control of the control unit 201, the distribution management DB 230 stores duplication device specifying information (a user ID, a duplication device ID for identifying a duplication device and an IP address of the duplication device) and a content unique ID associated with content for which duplication is aided, as distribution history information per duplication device which has aided duplication in order to allow the distribution server 200 to specify a duplication device which aided duplication in the past. That is, the control unit 201 records distribution history information in the distribution management DB every time duplication is aided. Further, even when whole content is updated to some duplication device connected through the network NW, in addition to duplication processing, the control unit 201 stores duplication device specifying information and a content unique ID associated with the uploaded content as distribution history information per duplication device.

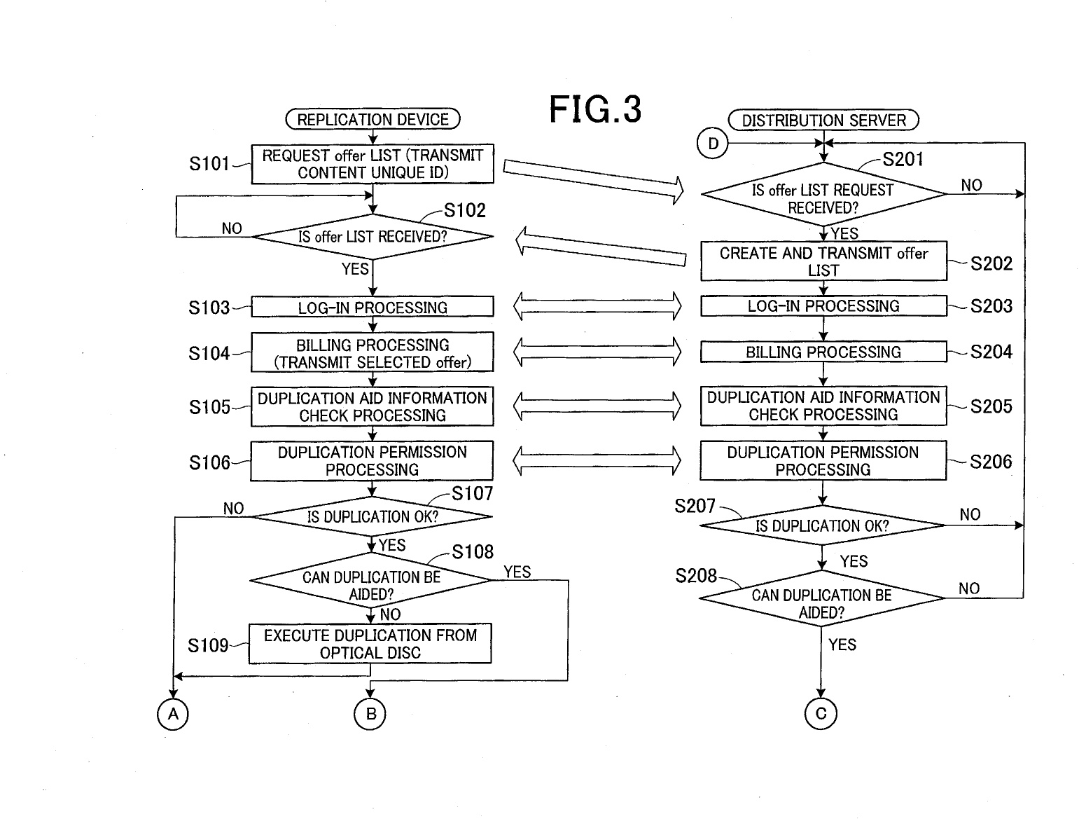

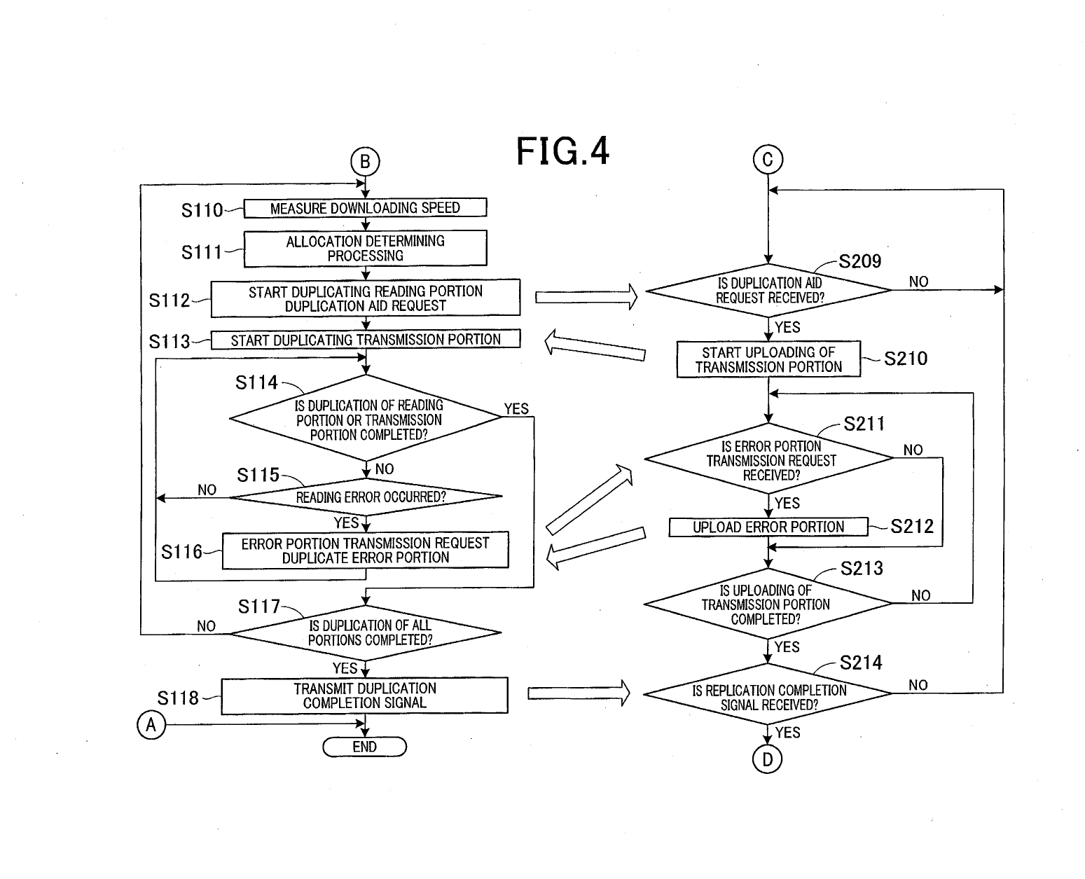

Next, an operation of the control unit 101 of the duplication device 100 and an operation of the control unit 201 of the distribution server 200 will be described using FIGS. 3 and 4. In addition, the processings illustrated in FIGS. 3 and 4 are started when the control unit 101 detects a user's operation of starting duplication processing. Further, the duplication device 100 is connected with the distribution server 200 through the network NW.

First, the control unit 101 of the duplication device 100 transmits a request of an offer list to the distribution server 200 as one of preprocessings (step S101). In this case, the control unit 101 transmits together a content unique ID for identifying content recorded in the recording disc D.

The offer list is information returned to the duplication device 100 when content associated with the content unique ID transmitted from the control unit 101 is stored in the content DB 220 of the distribution server 200. In the offer list, a list of content which is associated with the content unique ID transmitted from the control unit 101 and which can be duplicated, and a list of copying means are described. In case of, for example, animation content with a title “◯Δx” which are six episodes long, the offer list includes an option which the user can select as a copy target such as an option of copying all pieces of content from the first episode to the sixth episode included in animation content, an option of copying only content of the first episode or an option of selecting content of the first, second and third episodes. Further, in addition to the above options, the offer list also includes an option which the user can select according to the resolution of copied content or a device of an output destination such as a codec.

By contrast with this, the control unit 201 of the distribution server 200 is in a stand-by state until the offer list request is received (step S201: NO), and, when receiving the offer list request (step S201: YES), refers to the content DB 220, creates the offer list based on the received content unique ID received together and transmits the offer list to the duplication device 100 (step S202).

Meanwhile, when creating the offer list in processing of step S202, the control unit 201 refers to the content DB 220, and checks whether or not content associated with the received content unique ID is stored. Further, the control unit 201 creates the offer list per content associated with the content unique ID.

Meanwhile, the control unit 101 of the duplication device 100 is in the stand-by state until the offer list is received (step S102: NO), and, when receiving the offer list (step S102: YES), then performs log-in processing with respect to the distribution server 200 as one of preprocessings (step S103 and step S203). More specifically, the control unit 101 transmits a user ID and a password inputted by the user, a duplication ID and a log-in request, to the distribution server 200. By contrast with this, the control unit 201 of the distribution server 200 refers to the authentication DB 210, and authenticates the user based on the received user ID and the password. (In this case, user account information is created in advance.) Further, the control unit 201 permits log-in if no problem occurs in authentication, and records, for example, the user ID, the duplication ID and the IP address of the duplication device in the distribution management DB 230 as duplication device specifying information. Meanwhile, if a problem occurs in authentication, the distribution server 200 requests the duplication device 100 to retransmit, for example, the user ID and the password.

Next, the control unit 101 of the duplication device 100 and the control unit 201 of the distribution server 200 perform billing processing as one of preprocessings (step S104 and step S204). More specifically, the control unit 101 of the duplication device 100 transmits to the distribution server 200 a request message for obtaining permission of duplication of content the user selects from content which can be duplicated from the received offer list. By contrast with this, the control unit 201 of the distribution server 200 adds the amount of money matching duplication processing of duplication target content, to billing information of the user who logs in in log-in processing (step S103 and step S203).

Next, the control unit 101 of the duplication device 100 and the control unit 201 of the distribution server 200 perform duplication aid information checking processing as one of preprocessings (step S105 and step S205). More specifically, the control unit 201 of the distribution server 200 transmits to the duplication device 100 duplication aid information showing whether or not the distribution server 200 can aid duplication of duplication target content when billing processing (step S204) is performed. By contrast with this, the control unit 101 of the duplication device 100 checks the received duplication aid information. In addition, on the contrary, the control unit 101 of the duplication device 100 may be configured to inquire whether or not the distribution server 200 supports a duplication aid, and, following this inquiry, the control unit 201 of the distribution server 200 may be configured to transmit to the duplication device 100 duplication aid information showing whether or not the distribution server 200 can aid duplication of duplication target content when billing processing (step S204) is performed.

Next, the control unit 101 of the duplication device 100 and the control unit 201 of the distribution server 200 perform duplication permission processing as one of preprocessings (step S106 and step S206). More specifically, the control unit 101 of the duplication device 100 transmits a duplication request of duplication target content to the distribution server 200. By contrast with this, the control unit 201 of the distribution server 200 decides whether or not a problem occurs in the preprocessings performed so far (step S201 to step S205), transmits duplication permission information showing that duplication is permitted, to the duplication device 100 when no problem occurs, and transmits duplication non-permission information showing that duplication is not permitted, to the duplication device 100 when a problem occurs.

Next, the control unit 101 of the duplication device 100 decides whether or not duplication is permitted (step S107). More specifically, the control unit 101 decides which one of duplication permission and duplication non-permission information the information received from the distribution server 200 in processing of step S106 is. In this case, the control unit 101 finishes duplication processing when duplication is not permitted (step S107: NO). Meanwhile, the control unit 101 then decides whether or not duplication can be aided (step S108) when duplication is permitted (step S107: YES). More specifically, the control unit 101 decides whether or not the distribution server 200 can aid duplication, based on duplication aid information checked in processing of step S105. In this case, when deciding that duplication cannot be aided (step S108: NO), the control unit 101 executes duplication based only on reading of content from the optical disc D (step S109), and finishes duplication processing. Meanwhile, when deciding that duplication can be aided (step S108: YES), the control unit 101 proceeds to processing of step S110 (see FIG. 4).

On the other hand, the control unit 201 of the distribution server 200 decides whether or not duplication is permitted in processing of step S206 (step S207). In this case, the control unit 201 proceeds to processing of step S201 when duplication is not permitted (step S207: NO), and then decides whether or not duplication can be aided (step S208) when duplication is permitted (step S207: YES). More specifically, the control unit 201 decides whether duplication can be aided according to content of duplication aid information transmitted to the duplication device 100 in processing of step S206. In this case, the control unit 201 proceeds to processing of step S201 when deciding that duplication cannot be aided (step S208: NO), and proceeds to processing of step S209 (see FIG. 4) when deciding that duplication can be aided (step S208: YES).

Meanwhile, when deciding that duplication can be aided in processing of step S108, the control unit 101 of the duplication device 100 then measures the downloading speed S_{S} of data from the distribution server 200 (step S110). Next, the control unit 101 performs allocation determining processing (step S111). More specifically, the control unit 101 determines a data size of the reading portion R and a data size of the transmission portion T based on the reading speed S_{D}, the downloading speed S_{S} measured in processing of step S110 and a data size of a duplication target file (content), and allocates the reading portion R and the transmission portion T.

Next, the control unit 101 of the duplication device 100 starts reading and writing the reading portion R (duplicating the reading portion R), and transmits a duplication aid request to the distribution server 200 (step S112). In this case, the control unit 101 requests a duplication aid with respect to the transmission portion T determined in allocation determining processing (step S111). By contrast with this, the control unit 201 of the distribution server 200 is in the stand-by state until the duplication aid request is received from the duplication device 100 after processing of step S208 (step S209: NO), and, when receiving the duplication aid request (step S209: YES), starts uploading the transmission portion T for which the duplication aid request is received (step S210). Meanwhile, the control unit 101 of the duplication device 100 starts downloading and writing the transmission portion T (duplicating the transmission portion T) when the distribution server 200 starts uploading the transmission portion T (step S113).

Next, the control unit 101 of the duplication device 100 decides whether or not duplication of the reading portion R or duplication of the transmission portion T is completed (step S114). In this case, when deciding that neither duplication of the reading portion R nor duplication of the transmission portion T is completed (step S114: NO), the control unit 101 then checks whether or not a reading error of irrecoverable data occurs (step S115). More specifically, the control unit 101 checks whether or not error information is not received from the optical disc reading unit 102. In this case, when deciding that a reading error of irrecoverable data does not occur (step S115: NO), the control unit 101 proceeds to processing of step S114. Meanwhile, the control unit 101 transmits an error portion transmission request for requesting transmission of the error portion to the distribution server 200 based on error information when deciding that a reading error of irrecoverable data occurs (step S115: YES), and then downloads the error portion from the distribution server 200, replaces the error portion with the data and records the data in the hard disc 106 (step S116). The control unit 101 proceeds to processing of step S114 after processing of step S116. Thus, the control unit 101 repeats processing of step S115 and processing of step S116 (meanwhile, processing of step S116 is executed only when an error occurs) until duplication of the reading portion R or duplication of the transmission portion T is completed. Further, the control unit 101 proceeds to processing of step S117 when deciding that duplication of the reading portion R or duplication of the transmission portion T is completed (step S114: YES).

On the other hand, the control unit 201 of the distribution server 200 decides whether or not the error portion transmission request is received from the duplication server 100 while uploading data of the transmission portion T (step S211). In this case, the control unit 201 uploads the error portion to the duplication device 100 (step S212) and proceeds to processing of step S213 when receiving the error portion transmission request (step S211: YES), and proceeds to processing of step S213 as is when receiving no error portion transmission request (step S211: NO). Next, the control unit 201 decides whether or not uploading of the transmission portion T is completed (step S213). In this case, the control unit 201 proceeds to processing of step S211 when deciding that uploading of the transmission portion T is not completed (step S213: NO). That is, the control unit 201 uploads the transmission portion T while checking whether or not the error portion transmission request is not received from the duplication device 100 until uploading of the transmission portion T is completed. Meanwhile, the control unit 201 proceeds to processing of step S214 when deciding that uploading of the transmission portion T is completed (step S213: YES).

On the other hand, the control unit 101 of the duplication device 100 then decides whether or not duplication of all portions of duplication target content is completed when deciding that duplication of the reading portion R or duplication of the transmission portion T is completed in processing of step S114 (step S117). In this case, the control unit 101 proceeds to processing of step S110 when deciding that duplication of all portions is not completed (step S117: NO). That is, the control unit 101 performs processings of step 110 to step S116 until duplication of all portions is completed. Meanwhile, the control unit 101 transmits a duplication completion signal to the distribution server 200 (step S118) and finishes duplication processing when deciding that duplication of all portions is completed (step S117: YES).

On the other hand, the control unit 201 of the distribution server 200 then decides whether or not the duplication completion signal is received from the duplication device 100 (step S214) when deciding that uploading of the transmission portion T is completed in processing of step S213. In this case, the control unit 201 proceeds to processing of step S201 (see FIG. 3) when receiving the duplication completion signal (step S214: YES), and proceeds to processing of step S209 when receiving no duplication completion signal. In addition, the control unit 201 proceeds to processing of step S201 (see FIG. 3) when a sufficient time to decide that the duplication device 100 stops duplication processing passes in a state where a duplication aid request is not received from the duplication device 100 after proceeding from processing of step S214 to processing of step S209.

As described above, with the duplication system 1 (an example of “a content duplication system” according to the present invention) according to the first embodiment, in the duplication device 100 (an example of “a content duplication device” according to the present invention), the optical disc reading unit 102 (an example of “reading means” according to the present invention) reads the reading portion R (an example of “a first portion” according to the present invention) of duplication target content from the optical disc D (an example of “a first recording medium” according to the present invention), and the control unit 101 (an example of “acquiring means” according to the present invention) downloads the transmission portion T (an example of “a second portion” according to the present invention) of content which includes all portions other than the reading portion R from the distribution server 200 (an example of “a content distribution device” according to the present invention), in parallel to reading of the reading portion R by the optical disc reading unit 102. Further, the control unit 101 (an example of “recording means” according to the present invention) records the reading portion R read by the optical disc reading unit 102 and the downloaded transmission portion T in the hard disc 106 (an example of “a third recording medium” according to the present invention) at a speed faster than a speed at which the optical disc reading unit 102 reads data from the optical disc D.

Furthermore, in the distribution server 200, the content DB 220 (an example of “distribution content memory means” according to the present invention) stores a plurality of types of distribution content, and the control unit 201 (an example of “transmitting means” according to the present invention) uploads the transmission portion T to the duplication device 100 according to a transmission request from the control unit 101 of the duplication device 100.

Thus, the duplication system 1 or the duplication device 100 according to the first embodiment makes the optical disc reading unit 102 read the reading portion R and, in parallel, downloads the transmission portion T from the distribution server 200 when duplicating content, and records the read reading portion R and the downloaded transmission portion T in the hard disc 106. Consequently, when duplication is performed by recording in the hard disc 106 the same content as content recorded in the optical disc D, if the speed of reading content from the optical disc D is slower than the speed of writing content in the hard disc 106, it is possible to reduce the likelihood that the slow reading speed blocks reduction of the duplication time and eventually reduce the duplication time.

Further, the duplication device 100 according to the first embodiment downloads the transmission portion T only when the control unit 101 (an example of “transmitting means” according to the present invention) transmits a user ID and a password (an example of “information for obtaining permission of acquiring the second portion” according to the present invention) to the distribution server 200 (an example of “a permission device” according to the present invention) before downloading the transmission portion T from the distribution server 200, and the distribution server 200 permits log-in and duplication. Consequently, it is possible to prevent the duplication device 100 from downloading content for which the duplication device 100 does not obtain permission of duplication from the distribution server 200.

Further, with the duplication device 100 according to the first embodiment, the control unit 101 (an example of “determining means” according to the present invention) determines a data size of the reading portion R and a data size of the transmission portion T based on the reading speed S_{D} and the downloading speed S_{S}. Accordingly, the optimal data size of the reading portion R and data size of the transmission portion T matching the reading speed S_{D} and the downloading speed S_{S} are determined, so that it is possible to reduce the duplication time.

Further, when the control unit 101 completes reading of the reading portion R or downloading of the transmission portion T earlier, the duplication device 100 according to the first embodiment performs allocation determining processing of a portion of duplication target content which is not yet recorded in the hard disc 106. Accordingly, even when reading of the reading portion R or downloading of the transmission portion T is completed earlier for such a reason that the downloading speed S_{S} changes from the previous allocation determining processing, the optimal data size of the reading portion R and data size of the transmission portion T are determined again for a portion which is not yet duplicated, and the reading portion R is read and the transmission portion T is downloaded, so that it is possible to reduce the duplication time.

Further, with the duplication device 100 according to the first embodiment, the control unit 101 and the optical disc reading unit 102 (an example of “defect detecting means” according to the present invention) detect an error portion (an example of “a defect portion” according to the present invention) of content which cannot be read from the optical disc D, and the control unit 101 downloads the error portion from the distribution server 200. Accordingly, it is possible to prevent content including the error portion from being recorded in the hard disc 106, and improve duplication quality.

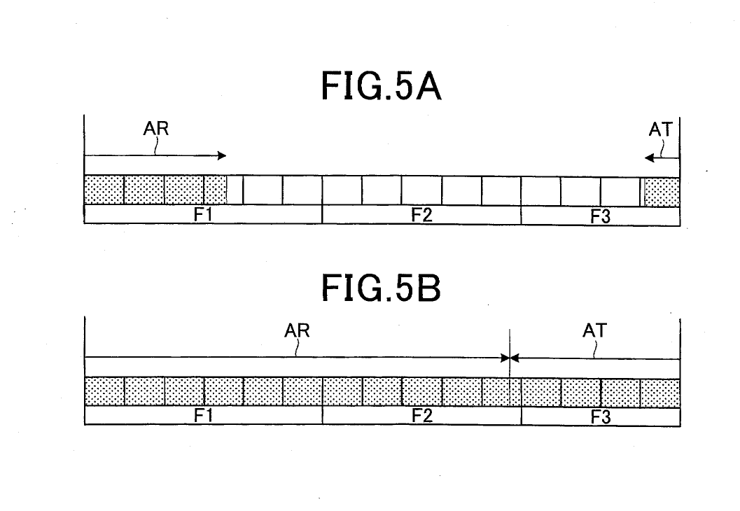

In addition, as described in the first embodiment using FIGS. 2A to 2D, the control unit 101 of the duplication device 100 duplicates the reading portion R and the transmission portion T from each head address (the left side in FIGS. 2A to 2D) after determining the data size of the reading portion R and the data size of the transmission portion T according to allocation determining processing. Instead of this, without performing allocation determining processing, the control unit 101 of the duplication device 100 may start duplication from the head address (the left side in FIG. 5A) of duplication target content as illustrated by an arrow AR in FIG. 5A based on reading by the optical disc reading unit 102, start duplication from a tail address (the right side in FIG. 5A) as illustrated by an arrow AT in FIG. 5A based on downloading from the distribution server 200 and finishes duplication processing at a time when both duplications meet as illustrated in FIG. 5B. In addition, in this case, content recorded states are managed upon both duplications by managing copy completed addresses at a given point of time based on the above address information.

### Second Embodiment

Next, the second embodiment will be described using FIGS. 6 to 8. In addition, with the second embodiment, the same members and processings as the members and processings described in the first embodiment will be assigned the same reference numerals, and will not be described.

As illustrated in FIG. 6, with the second embodiment, a duplication system 2 has the duplication device 100 which performs duplication processing, the distribution server 200 and other duplication devices 300-1 to 300-n which store duplication target content, and these are connected through the network NW.

Features of the duplication device 100 according to the second embodiment include downloading the transmission portion T from the other duplication devices 300-1 to 300-n while the duplication device 100 according to the first embodiment downloads the transmission portion T from the distribution server 200.

More specifically, the duplication device 100 according to the second embodiment reads a portion of content to record in the hard disc 106, from the optical disc D, and, in parallel to this, downloads the other portion from the other duplication device 300-1 to 300-n which store the same content and duplicates the content by recording the other portion in the hard disc 106. In this case, the duplication device 100 stores the same content as duplication target content created by the distribution server 200 and downloads this content based on a list (“available duplication device list” described below) of the duplication devices 300-1 to 300-n which can upload this content.

Further, with the second embodiment, a duplication aid according to the second embodiment refers to, when the duplication device 100 duplicates content, (1) transmitting an available duplication device list from the distribution server 200 to the duplication device 100 and (2) uploading a portion of content from the duplication devices 300-1 to 300-n to the duplication device 100. That is, with the second embodiment, the distribution server 200 performs a duplication server, and the duplication devices 300-1 to 300-n perform a duplication aid.

The control unit 101 of the duplication device 100 according to the second embodiment sends a transmission request of an available duplication device list as a duplication aid request to the distribution server 200 after performing various preprocessings described in the first embodiment. The available duplication device list is a list of the duplication devices 300-1 to 300-n which can aid duplication according to the second embodiment. The duplication devices registered in the available duplication device list satisfy registration requirements that (1) duplication of the same content as duplication target content was aided by the distribution server 200 as described in the first embodiment or whole content was downloaded from the distribution server 200 in the past, (2) the content is still stored in a hard disc (that is, the content is not yet deleted) and (3) communication can be carried out through the network NW at the time when the available duplication device list is created. In addition, the duplication devices included in the available duplication device list are referred to as “available duplication devices”.

When receiving the available duplication device list from the distribution server 200, the control unit 101 transmits and receives data to and from each of the available duplication devices 300-1 to 300-n registered in the list, and measures each downloading speed S_{S}. Further, the control unit 101 determines a data size of the reading portion R and a data size of each transmission portion T downloaded from each of the available duplication devices 300-1 to 300-n based on a speed ratio of the reading speed of the optical disc reading unit 102 and the downloading speed S_{S} of each of the available duplication devices 300-1 to 300-n, and allocates the reading portion R and the transmission portion T of each of the available duplication devices 300-1 to 300-n. Thus, processing of determining a data size of the reading portion R and a data size of the transmission portion T is referred to as “allocation determining processing” according to the second embodiment.

When determining the reading portion R and the transmission portion T after allocation determining processing according to the second embodiment, the control unit 101 starts reading the reading portion R and downloading the transmission portion T from each of the available duplication devices 300-1 to 300-n and, similar to the first embodiment, allocation determining processing according to the second embodiment, and duplication of the reading portion R and duplication of the transmission portion T accompanying this allocation determining processing are subsequently repeated for a portion which is not yet duplicated every time duplication of the reading portion R or duplication of the transmission portion T is completed.

Further, similar to the first embodiment, when receiving error information from the optical disc reading unit 102, the control unit 101 sends an error portion transmission request for requesting transmission of the error portion to one of the available duplication devices 300. Furthermore, the control unit 101 receives the error portion transmitted from the available duplication device 300 in response to the error portion transmission request, replaces the reading portion which cannot be read by the optical disc reading unit 102 with the received data, and records the data in the hard disc 106.

Next, the distribution server 200 according to the second embodiment will be described. The control unit 201 of the distribution server 200 according to the second embodiment creates an available duplication device list when receiving a transmission request of the available duplication device list from the duplication device 100. More specifically, the control unit 201 sequentially accesses duplication devices which upload the transmission portion T of the same content as duplication target content or upload the whole content, based on distribution history information stored in the distribution management DB 230, and registers duplication devices which satisfy the above registration requirements, in the available duplication device list as available duplication devices.

Meanwhile, by decreasing the priority of a registration order for duplication devices which have poor connectivity of failing connection a predetermined number of times in a fixed period or duplication devices which are continuously decided to have a slow communication speed, the control unit 201 may make a device of reducing a time required for registration or improving performance upon a duplication aid.

Further, when it is possible to check by some means that corresponding content is deleted from duplication devices, it is desirable to delete registration of corresponding duplication devices from the distribution management DB 230, and reduce a wasteful time for the above registration.

In addition, the number of available duplication devices registered in the available duplication device list is n at maximum. That is, the control unit 201 completes creating the available duplication device list when the number of available duplication devices registered in the available duplication device list reaches n or when all duplication devices which are access targets specified according to distribution history information are accessed. Further, when creating the available duplication device list, the control unit 201 transmits the available duplication device list to the duplication device 100.

Next, the available duplication devices 300-1 to 300-n according to the second embodiment will be described. In addition, each of the available duplication devices 300-1 to 300-n employs the same configuration as the duplication device 100.

The available duplication devices 300-1 to 300-n release items of content stored in hard discs of them and content unique IDs associated with these items of content, to the distribution server 200 and the duplication device 100 while they are connected to the network NW in a powered-on state. Further, when receiving a transmission request of the transmission portion T as a duplication aid request from the duplication device 100, the available duplication devices 300-1 to 300-n upload the transmission portion T.

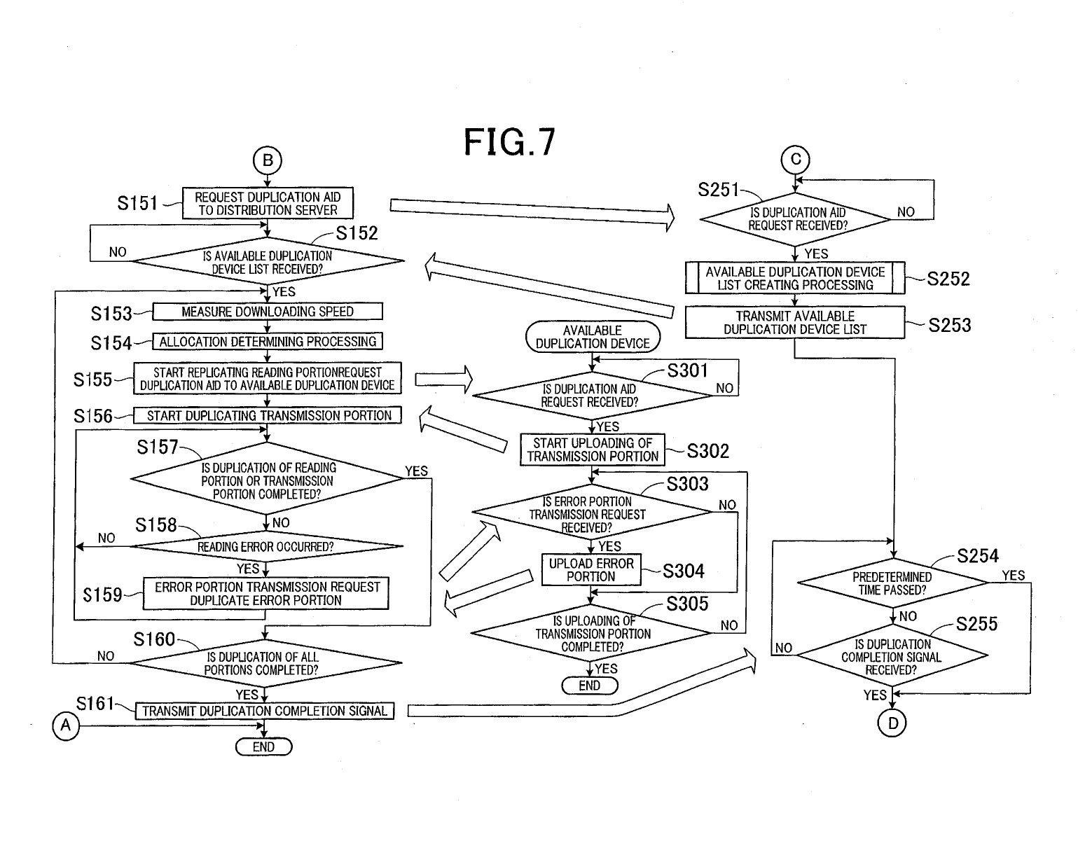

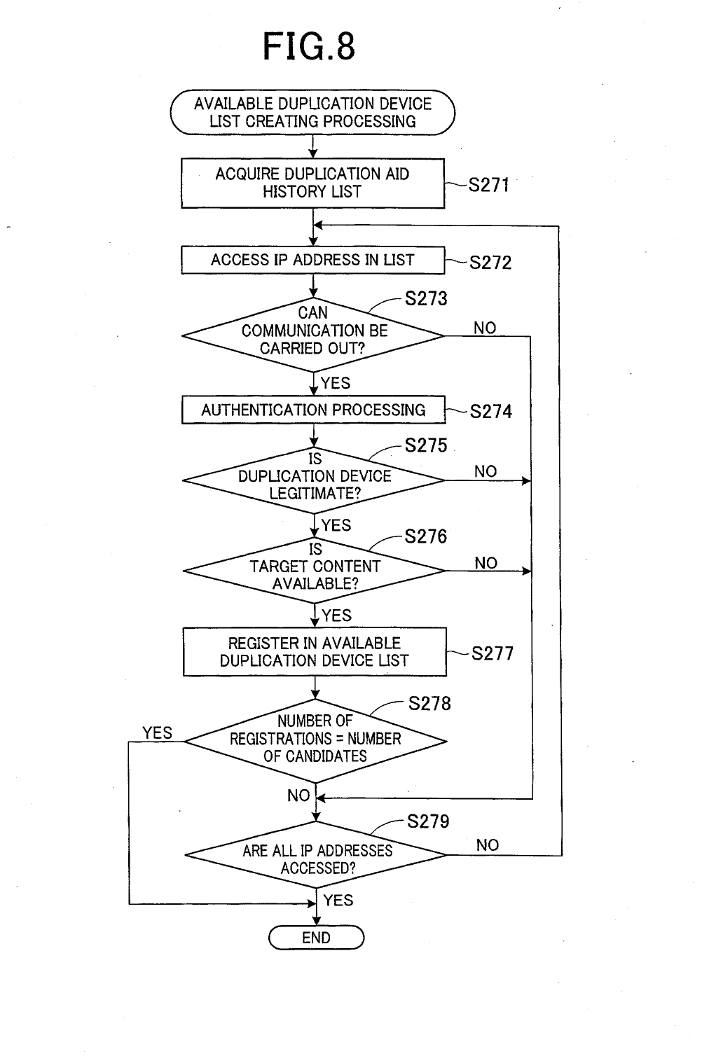

Next, an operation of the control unit 101 of the duplication device 100, an operation of the control unit 201 of the distribution server 200 and an operation of a control unit of the available duplication device 300 according to the second embodiment will be described using FIGS. 3, 7 and 8. In addition, the point which has been described in the first embodiment using FIG. 3 also applies to the second embodiment, and therefore processings of the control unit 101 of the duplication device 100 from step S101 to step S109 and processings of the control unit 201 of the distribution server 200 from step S201 to step S208 will not be described and the subsequent processings will be described using FIGS. 7 and 8.

When deciding that duplication can be aided in processing of step S108 in FIG. 3 (step S108: YES), the control unit 101 of the duplication device 100 then transmits a duplication aid request (that is, a creation request of the available duplication device list) to the distribution server 200 as illustrated in FIG. 7 (step S151). Meanwhile, the control unit 201 of the distribution server 200 is in the stand-by state until a duplication aid request is received from the duplication device 100 after processing of step S208 in FIG. 3 (step S251: NO), and, when receiving the duplication aid request (step S251: YES), creates the available duplication device list (step S252).

Hereinafter, available duplication device list creating processing by the control unit 201 of the distribution server 200 will be described using FIG. 8.

First, the control unit 201 acquires a duplication aid history list which describes duplication devices which aided duplication of current duplication target content in the past, based on a content unique ID received from the duplication device 100 in processing of step S201 and processing of step S204 in FIG. 3 (step S271). More specifically, referring to distribution history information in the distribution management DB 230, the control unit 201 acquires a duplication aid history list including duplication device IDs and IP addresses of duplication devices which aided duplication or uploaded whole content in the past, for content associated with the content unique ID received from the duplication device 100.

Next, the control unit 201 accesses one IP address in the duplication aid history list (step S272). Further, the control unit 201 decides whether or not communication can be carried out (step S273). In this case, the control unit 201 proceeds to processing of step S279 when deciding that communication cannot be carried out (step S273: NO), and performs authentication (step S274) when deciding that communication can be carried out (step S273: YES). More specifically, in processing of step S274, the control unit 201 requests transmission of a duplication device ID to a duplication device of an access destination, decides whether or not the received duplication ID is identical with a duplication device ID in the duplication aid list, and, if the duplication device ID is identical, authenticates the duplication device as a legitimate duplication device. In addition, authentication using digital signature may be performed to check whether or not a duplication device ID is not falsified. In addition, means for authentication is not limited to the above user of a duplication ID, and authentication using other appropriate information may be performed.

Next, the control unit 201 decides whether or not the duplication device is legitimate as a result of authentication (step S275). In this case, the control unit 201 proceeds to step S279 when deciding that the duplication device is not legitimate (step S275: NO), and then decides whether or not target content is available (step S276) when deciding that the duplication device is legitimate (step S275: YES). More specifically, the control unit 201 decides whether or not the same content as duplication content is still stored in a hard disc and is released in a state where the content can be downloaded from another device.

The control unit 201 proceeds to processing of step S279 when deciding that target content is not available (step S276: NO), and registers the duplication device of an access destination in the available duplication list as an available duplication device (step S277) when deciding that the target content is available (step S276: YES). More specifically, the control unit 201 registers in the available duplication device list a duplication device ID and an IP address of the available duplication device, and a content unique ID associated with content for which duplication can be aided.

Next, the control unit 201 decides whether or not the number of registrations in the available duplication device list reaches a predetermined number n. Meanwhile, when the number of available duplication device candidates registered in distribution history information in the distribution management DB 230 is n or less, creation of the available duplication device list is completed at a point of time when the number of registrations reaches the number of candidates (step S278). A value of n is adequately set according to, for example, a time which can be spent to create the available duplication device list. In addition, while, when the n value is set higher, the number of available duplication devices which upload the transmission portion T increases and it is possible to increase a data size of the transmission portion T, the time to create the available duplication device list becomes long and the time to download the transmission portion T decreases.

The control unit 201 finishes available duplication device list creating processing when deciding that the number of registrations in the available duplication device list reaches the predetermined number n or when deciding that the number of registrations reaches the number of candidates in case where the number of available duplication device candidates registered in distribution history information in the distribution management DB 230 is less than n (step S278: YES). Meanwhile, the control unit 201 proceeds to processing of step S279 when deciding that the number of registrations in the available duplication device list does not reach the predetermined number n or when deciding that the number of registrations does not reach the number of candidates in case where the number of available duplication device candidates registered in distribution history information in the distribution management DB 230 is less than n (step S278: NO).

When deciding “NO” in one of processing of step S273, processing of step S275, processing of step S276 and processing of step S278, the control unit 201 then decides whether or not all IP addresses in the duplication aid history list are accessed (step S279). In this case, when deciding that all IP addresses are accessed (step S279: YES), the control unit 201 finishes available duplication device list creating processing. Meanwhile, when deciding that all IP addresses are not accessed (step S279: NO), the control unit 201 proceeds to processing of step S272. That is, the control unit 201 finishes available duplication device list creating processing when all IP addresses in the duplication aid history list are accessed or when the number of registrations in the available duplication device list reaches n.

When the available duplication device list is created, the control unit 201 transmits the created available duplication device list to the duplication device 100 as illustrated in FIG. 7 (step S253).

Meanwhile, the control unit 101 of the duplication device 100 is in the stand-by state until the available duplication device list is received after processing of step S151 is performed (step S152: NO), and, when receiving the available duplication device list (step S152: YES), then refers to an IP address in the available duplication device list, accesses each of the available duplication devices 300-1 to 300-n and measures each of the downloading speed S_{S} (step S153). Next, the control unit 101 performs allocation determining processing according to the second embodiment (step S154).

When determining the reading portion R and the transmission portion T after allocation determining processing according to the second embodiment, the control unit 101 starts reading and writing the reading portion R (duplicating the reading portion R) and transmitting a duplication aid request to each of the available duplication devices 300-1 to 300-n (step S155). By contrast with this, a control unit of each of the available duplication devices 300-1 to 300-n is in the stand-by state until the duplication aid request is received from the duplication device 100 (step S301: NO), and, when receiving the duplication aid request (step S301: YES), starts uploading the transmission portion T for which a duplication aid is requested (step S302). Meanwhile, the control unit 101 of the duplication device 100 starts downloading and writing the transmission portion T (duplicating the transmission portion T) when each of the available duplication devices 300-1 to 300-n starts uploading the transmission portion T (step S156).

Further, although not illustrated, when sending a downloading request to each available duplication device 300, the control unit 101 of the duplication device 100 transmits information showing that permission information received from the distribution server 200 is legitimate, to each available duplication device 300. Each available duplication device 300 verifies the above information received from the duplication device 100, checks that the duplication device 100 has legitimate permission information and then starts providing content.

Next, the control unit 101 of the duplication device 100 decides whether or not duplication of the reading portion R or duplication of the transmission portion T is completed (step S157). In this case, when deciding that neither duplication of the reading portion R nor duplication of the transmission portion T is completed (step S157: NO), the control unit 101 then checks whether or not a reading error of irrecoverable data occurs (step S158). In this case, when deciding that a reading error of irrecoverable data does not occur (step S158: NO), the control unit 101 proceeds to processing of step S157. Meanwhile, the control unit 101 sends an error portion transmission request for requesting transmission of an error portion to one of the available duplication devices 300 (for example, an available duplication device of the fastest downloading speed S_{S}) based on error information when deciding that the reading error of irrecoverable data occurs (step S158: YES), and then downloads the error portion from the available duplication device 300, replaces the error portion with the data and records the data in the hard disc 106 (step S159). When processing of step S159 is finished, the control unit 101 proceeds to processing of step S157. Thus, the control unit 101 repeats processing of step S158 and processing of step S159 (meanwhile, processing of step S159 is executed only when an error occurs) until duplication of the reading portion R or duplication of the transmission portion T is completed. Further, the control unit 101 proceeds to processing of step S160 when deciding that duplication of the reading portion R or duplication of the transmission portion T is completed (step S157: YES).

On the other hand, the control unit of each of the available duplication devices 300-1 to 300-n decides whether or not the error portion transmission request is received from the duplication server 100 while uploading the transmission portion T (step S303). In this case, the control unit of each of the available duplication devices 300-1 to 300-n uploads the error portion to the duplication device 100 (step S304) and proceeds to processing of step S305 when receiving the error portion transmission request (step S303: YES), and proceeds to processing of step S305 as is when receiving no error portion transmission request (step S303: NO). Next, the control unit of each of the available duplication devices 300-1 to 300-n decides whether or not uploading of the transmission portion T is completed (step S305). In this case, the control unit of each of the available duplication devices 300-1 to 300-n proceeds to step S303 when deciding that uploading of the transmission portion T is not completed (step S305: NO). That is, the control unit of each of the available duplication devices 300-1 to 300-n uploads the transmission portion T while checking whether or not the error portion transmission request is not received from the duplication device 100 until uploading of the transmission portion T is completed. Meanwhile, the control unit of each of the available duplication devices 300-1 to 300-n finishes processing of the duplication aid request when deciding that uploading of the transmission portion T is not completed (step S305: YES).

Meanwhile, the control unit 101 of the duplication device 100 then decides whether or not duplication of all portions of duplication target content is completed (step S160) when deciding that duplication of the reading portion R or duplication of the transmission portion T is completed in processing of step S157. In this case, the control unit 101 proceeds to processing of step S153 when deciding that duplication of all portions is not completed (step S160: NO). That is, the control unit 101 performs processings of step 153 to step S159 until duplication of all portions is completed. Meanwhile, the control unit 101 transmits a duplication completion signal to the distribution server 200 (step S161) and finishes duplication processing when deciding that duplication of all portions is completed (step S160: YES).

In addition, in some cases, each of the available duplication devices 300-1 to 300-n is powered off during downloading. Although not illustrated, a configuration may be employed where, when the duplication device 100 detects such a state, information of a substitute available duplication device is requested to the distribution server 200 where necessary.

On the other hand, the control unit 201 of the distribution server 200 decides whether or not a predetermined time passes after the available duplication device list is transmitted in processing of step S253 (step S254). The predetermined time is set as a time which is sufficient to decide that the duplication device 100 stops duplication processing. In this case, the control unit 201 proceeds to processing of step S201 (see FIG. 3) when deciding that the predetermined time passes (step S254: YES), and then decides whether or not the duplication completion signal is received from the duplication device 100 (step S255) when deciding that the predetermined time does not pass (step S254: NO). In this case, the control unit 201 proceeds to processing of step S201 (see FIG. 3) when receiving the duplication completion signal (step S255: YES), and proceeds to processing of step S254 when receiving no duplication completion signal. That is, the control unit 201 repeats processing of step S254 or processing of step S255 until the predetermined time passes or an aid completion signal is received after processing of step S253 is finished.

As described above, with the duplication system 2 according to the second embodiment, in the duplication device 100 (an example of “a content duplication device” according to the present invention), the optical disc reading unit 102 (an example of “reading means” according to the present invention) reads the reading portion R (an example of “the first portion” according to the present invention) of content from the optical disc D (an example of “the first recording medium” according to the present invention), and the control unit 101 (an example of “list receiving means” according to the present invention) receives an available duplication device list (an example of “a list of content memory devices to which a content distribution device has distributed the same content as content recorded in the first recording medium” according to the present invention) from the distribution server 200 and, further, the control unit 101 (an example of “acquiring means” according to the present invention) makes the optical disc reading unit 102 read the reading portion R and, in parallel, downloads the transmission portion T (an example of “the second portion” according to the present invention) of content which includes all portions other than the reading portion R, from the available duplication device 300 included in the received available duplication device list. Further, the control unit 101 (an example of “recording means” according to the present invention) records the reading portion R read by the optical disc reading unit 102 and the downloaded transmission portion T in the hard disc 106 (an example of “a third recording medium” according to the present invention) at a speed faster than a speed at which the optical disc reading unit 102 reads data from the optical disc D.

Furthermore, with the distribution server 200, the content DB 220 (an example of “distribution content memory means” according to the present invention) stores a plurality of types of distribution content, and the distribution management DB 230 and the control unit 201 (an example of “distribution history managing means” according to the present invention) manage distribution history information showing to which one of duplication devices content is distributed, per content stored in the content DB 220. Still further, the control unit 201 (an example of “list transmitting means” according to the present invention) transmits the available duplication device list based on distribution history information, to the duplication device 100.

Moreover, with the available duplication device 300, the hard disc of the available duplication device 300 stores content distributed from the distribution server 200 and the control unit (an example of “transmitting means” according to the present invention) of the available duplication device 300 transmits the transmission portion T to the duplication device 100 according to a transmission request from the control unit 101 of the duplication device 100.

Thus, the duplication system 2 or the duplication device 100 according to the second embodiment makes the optical disc reading unit 102 read the reading portion R and downloads the transmission portion T from each of the available duplication devices 300 when duplicating content, and records the reading portion R and the transmission portion T in the hard disc 106. Consequently, when duplication is performed by recording in the hard disc 106 the same content as content recorded in the optical disc D, if the speed of reading content from the optical disc D is slower than the speed of writing content in the hard disc 106, it is possible to reduce the likelihood that the slow reading speed blocks reduction of the duplication time and eventually reduce the duplication time.

Further, the duplication device 100 according to the second embodiment downloads the transmission portion T only when the control unit 101 (an example of “transmitting means” according to the present invention) transmits a user ID and a password (an example of “information for obtaining permission of acquiring the second portion” according to the present invention) to the distribution server 200 (an example of “a permission device” according to the present invention) before downloading the transmission portion T from each of the available duplication devices 300, and the distribution server 200 permits log-in and duplication. Consequently, it is possible to prevent the duplication device 100 from downloading content for which the duplication device 100 does not obtain permission of duplication from the distribution server 200.

Further, with the duplication device 100 according to the second embodiment, the control unit 101 (an example of “determining means” according to the present invention) determines a data size of the reading portion R and a data size of the transmission portion T associated with each available duplication device 300, based on the reading speed S_{D} and the downloading speed S_{S} of each of the available duplication devices 300. Accordingly, the optimal data size of the reading portion R and data size of the transmission portion T matching the reading speed S_{D} and the downloading speed S_{S} are determined, so that it is possible to reduce the duplication time.

Further, when the control unit 101 completes reading of the reading portion R or downloading of the transmission portion T earlier, the duplication device 100 according to the second embodiment performs allocation determining processing according to the second embodiment for a portion of duplication target content which is not yet recorded in the hard disc 106. Accordingly, even when reading of the reading portion R or downloading of the transmission portion T is completed earlier for such a reason that the downloading speed S_{S} changes from the previous allocation determining processing, the optimal data size of the reading portion R and data size of the transmission portion T are determined again for a portion which is not yet duplicated, and the reading portion R is read and the transmission portion T is downloaded, so that it is possible to reduce the duplication time.

Further, with the duplication device 100 according to the second embodiment, the control unit 101 and the optical disc reading unit 102 (an example of “defect detecting means” according to the present invention) detect an error portion (an example of “a defect portion” according to the present invention) of content which cannot be read from the optical disc D, and the control unit 101 downloads the error portion from one of the available duplication devices 300. Accordingly, it is possible to prevent content including the error portion from being recorded in the hard disc 106, and improve duplication quality.

In addition, the control unit 201 of the distribution server 200 according to the second embodiment creates the available duplication device list as described using FIG. 7 (step S252), and transmits the available duplication device list to the duplication device 100 (step S253). By contrast with this, the control unit 101 of the duplication device 100 downloads the transmission portion T from each of the available duplication devices 300-1 to 300-n in the available duplication device list. Instead of this, when finding an available duplication device by processing of step S272 to processing of step S276 in FIG. 8, the control unit 201 of the distribution server 200 may report to the duplication device 100 information (for example, a duplication device ID, an IP address and a content unique ID associated with content which can be duplicated) related to the available duplication device instead of registering the available duplication device in the available duplication device list in processing of step S277. By contrast with this, the control unit 101 of the duplication device 100 starts duplication based on reading from the optical disc D when starting duplication processing, and starts duplication based on downloading of a portion which is not yet duplicated, from the reported available duplication device every time the report is received from the distribution server 200. In this case, every time the duplication device 100 receives the report, the number of downloading destinations increases and a duplication speed increases, so that it is possible to reduce the duplication time.

Although each embodiment has been described above, a duplication device program corresponding to processing by the control unit 101 of the duplication device 100 according to each embodiment may be recorded in an information recording medium such as a non-volatile memory, and read and executed by a computer to use the computer as the control unit 101 of the duplication device 100 according to the present embodiment.

Similarly, a distribution server program corresponding to processing by the control unit 201 of the distribution server 200 according to each of the above embodiments may be recorded in an information recording medium such as a non-volatile memory, and read and executed by a computer to use the computer as the control unit 201 of the distribution server 200 according to the present embodiment.

Further, an available duplication device program corresponding to processing by the control unit of the available duplication device 300 according to each of the above embodiments may be recorded in an information recording medium such as a non-volatile memory, and read and executed by a computer to use the computer as the control unit of the available duplication device 300 according to the present embodiment.

1. A content duplication device comprising:
a reading unit which reads a first portion configuring content from a first recording medium in which the content is recorded;
an acquiring unit which, in parallel to the reading of the first portion by the reading unit, acquires a second portion which is different from the first portion and which configures the content, from a second recording medium which is different from the first recording medium and in which at least a portion of a same content as the content is recorded; and
a recording unit which records the first portion read by the reading unit and the second portion acquired by the acquiring unit in a third recording medium at a speed faster than a speed at which the reading unit reads the first portion.

2. The content duplication device according to claim 1,
further comprising a transmitting unit which transmits information for obtaining permission of acquiring the second portion, to a permission device before the acquiring unit acquires the second portion from the second recording medium,
wherein the acquiring unit acquires the second portion only when the permission device permits acquisition of the second portion.

3. The content duplication device according to claim 2,
wherein the information for obtaining the permission is generated from information recorded in the first recording medium.

4. The content duplication device according to claim 1,
further comprising a determining unit which performs determining processing of determining a data size of the first portion and a data size of the second portion in the third recording medium, based on a reading speed at which the reading unit reads data from the first recording medium and an acquiring speed at which the acquiring unit acquires data from the second recording medium.

5. The content duplication device according to claim 4,
wherein, when any one of reading of the first portion by the reading unit or acquisition of the second portion by the acquiring unit is completed earlier, the determining unit performs the determining processing of a portion of content which is not yet recorded in the third recording medium.

6. The content duplication device according to claim 1,
further comprising a defect detecting unit which detects a defect portion of the content which the reading unit cannot read from the first recording medium,
wherein the acquiring unit acquires the detected defect portion from the second recording medium.

7. The content duplication device according to claim 1,
wherein the first recording medium is a locally connected recording medium, and
the second recording medium is a recording medium connected through a network.

8. The content duplication device according to claim 7,
wherein the first recording medium is an optical recording medium.

9. The content duplication device according to claim 8,
wherein the third recording medium is a hard disc.

10. A content duplication system comprising:
a content duplication device which duplicates content recorded in a first recording medium; and
a content distribution device which distributes at least a portion of content,
wherein the content duplication device comprises:
a reading unit which reads a first portion configuring the content from the first recording medium;
an acquiring unit which, in parallel to the reading of the first portion by the reading unit, acquires a second portion which is different from the first portion and which configures the content, from the content distribution device which is a medium different form the first recording medium; and
a recording unit which records the first portion of the content read by the reading unit and the second portion of the content acquired by the acquiring unit in a third recording medium at a speed faster than a speed at which the reading unit reads the first portion, and
the content distribution device comprises:
a distribution content memory unit which stores a plurality types of distribution content; and
a transmitting unit which transmits the second portion to the content duplication device.

11. A content duplication system comprising:
a content duplication device which duplicates content recorded in a first recording medium;
a content distribution device which distributes content; and
a content memory device which stores the content distributed from the content distribution device,
wherein the content duplication device comprises:
a reading unit which reads a first portion of the content from the first recording medium;
a list receiving unit which receives, from the content distribution device, a list of distribution destinations to which the content distribution device has previously distributed a same content as the content recorded in the first recording medium;
an acquiring unit which, in parallel to the reading of the first portion by the reading unit, acquires a second portion which is different from the first portion and which configures the content, from the content memory device which is a medium different form the first recording medium and which is included in the received list; and
a recording unit which records the first portion of the content read by the reading unit and the second portion of the content acquired by the acquiring unit in a third recording medium at a speed faster than a speed at which the reading unit reads the first portion,
the content distribution device comprises:
a distribution content memory unit which stores a plurality types of distribution content; and
a distribution history management unit which manages distribution history information showing that content is distributed to which one of the content memory devices, per content stored in the distribution content memory unit; and
a transmitting unit which transmits, to the content duplication device, a list which is based on the distribution history information and which includes the content memory devices to which same content as the content recorded in the first recording medium has been distributed, and
the content memory device comprises a transmitting unit which transmits the second portion to the content duplication device.

12. The content duplication device according to claim 2, further comprising a determining unit which performs determining processing of determining a data size of the first portion and a data size of the second portion in the third recording medium, based on a reading speed at which the reading unit reads data from the first recording medium and an acquiring speed at which the acquiring unit acquires data from the second recording medium.

13. The content duplication device according to claim 3, further comprising a determining unit which performs determining processing of determining a data size of the first portion and a data size of the second portion in the third recording medium, based on a reading speed at which the reading unit reads data from the first recording medium and an acquiring speed at which the acquiring unit acquires data from the second recording medium.

14. The content duplication device according to claim 2,
further comprising a defect detecting unit which detects a defect portion of the content which the reading unit cannot read from the first recording medium,
wherein the acquiring unit acquires the detected defect portion from the second recording medium.

15. The content duplication device according to claim 3,
further comprising a defect detecting unit which detects a defect portion of the content which the reading unit cannot read from the first recording medium,
wherein the acquiring unit acquires the detected defect portion from the second recording medium.

16. The content duplication device according to claim 4,
further comprising a defect detecting unit which detects a defect portion of the content which the reading unit cannot read from the first recording medium,
wherein the acquiring unit acquires the detected defect portion from the second recording medium.

17. The content duplication device according to claim 5,
further comprising a defect detecting unit which detects a defect portion of the content which the reading unit cannot read from the first recording medium,
wherein the acquiring unit acquires the detected defect portion from the second recording medium.

18. The content duplication device according to claim 2,
wherein the first recording medium is a locally connected recording medium, and
the second recording medium is a recording medium connected through a network.

19. The content duplication device according to claim 3,
wherein the first recording medium is a locally connected recording medium, and
the second recording medium is a recording medium connected through a network.

20. The content duplication device according to claim 4,
wherein the first recording medium is a locally connected recording medium, and
the second recording medium is a recording medium connected through a network.
